(19) United States
(12) Patent Application Publication
(10) Pub. No.: US 2004/0198860 A1
(43) Pub. Date: Oct. 7, 2004

(54) Method for the manufacture of a plastic film material suitable for implantation and stent formed using it

(76) Inventors: Hendrik Glastra, Enschede (NL); Paul de Kleijn, Voorthuizen (NL)

Correspondence Address: OSTROLENK FABER GERB & SOFFEN, 1180 AVENUE OF THE AMERICAS, NEW YORK, NY, 100368403

(21) Appl. No.: 10/484,997

(22) PCT Filed: Jul. 19, 2002
(86) PCT No.: PCT/NL02/00490

(30) Foreign Application Priority Data
Jul. 24, 2001 (NL) 1018619

(51) Int. Cl. C08J 3/28

(52) U.S. Cl. 522/39

(57) ABSTRACT

Method for the manufacture of a plastic film material suitable for implantation, by providing a pharmaceutically acceptable, flexible plastic carrier material with a layer of a photopolymerizable synthetic resin composition containing a photo-initiator, which is given a tack-reducing component. This component is chosen from polyurethane, an initiator or a mixture thereof. The initiator preferably generates a curing accelerator after activation. The invention also relates to an expandable intravascular stent obtained using this material.

The invention relates to a method for the manufacture of a plastic film material suitable for implantation, by providing a pharmaceutically acceptable, flexible plastic carrier material with a layer of a photopolymerizable synthetic resin composition containing a photo-initiator.

Such a plastic film material, in the form of an adhesive composition, is suggested in European Patent Application No. 0 617 930. This known material is contained in a double-walled case, however, when it is used as a stent. The external diameter of a stent must not be too large, since the stent has to be inserted into a vein and serves to strengthen weak spots in the wall of the vein; nor, in order to maintain adequate circulation through the blood vessel, may the internal diameter of the stent after application in the vein be too small.

Another requirement to be satisfied by a stent is that it must have a certain degree of flexibility in a longitudinal direction in order to imitate the natural state of a vein as well as possible. It is desirable, therefore, that the material of which the stent is made should have a small thickness, preferably up to 15 μm, but while retaining strength and flexibility in a longitudinal direction.

In order to facilitate the placing of a stent in a vein, the film material of the stent is rolled up (as is illustrated in FIG. 3 of EP-A-0 617 930) and the rolled-up stent is brought to the desired place in a vein with the aid of the catheter, extended or unrolled with the aid of a balloon incorporated in the catheter, and then cured by exposure to light.

An acrylate resin composition is usually employed as the photopolymerizable composition. In an uncured state, however, such a resin composition has such a tack that use thereof is possible only when the composition is incorporated as a sandwich between other layers, as is the case with the case body according to EP-A-0 617 930.

With the aim of making the thickness of the stent smaller, therefore, a photopolymerizable synthetic resin composition would be desirable which renders the presence of a case body unnecessary and yet can still be rolled up and unrolled, in an uncured state, without changing the thickness of the composition.

A method has now been found for the manufacture of a plastic film material suitable for implantation, of the type mentioned in the preamble, which is characterized in that the synthetic resin composition is provided with a tack-reducing synthetic resin component. An example of such a component is polyurethane.

Because of the use of the plastic film material in question as implantation material, it is essential that no substances poisonous to the body, originating from the polymerization initiator, are released during curing of the material. It has now been found that this can be prevented by using photo-initiators which are themselves already a polymer. An example of such an initiator is the oligomer of 2-hydroxy-2-methyl-1-[4-(1-methylvinyl)-phenyl]-propanone, also known as Esacure kip 150, from the company Lamberti SpA. This initiator, however, requires a fairly long exposure time of usually about 2 min, which is actually too long under certain conditions.

Accelerated curing can be achieved by adding an accelerator such as a tertiary amine having α-H atoms.

A problem with such accelerators, however, is that they have to be added at such a high concentration that they can exhibit cytotoxic properties.

It has now been found that the problem of the formation of poisonous degradation products from the accelerator, and the problem of the long exposure time, can be prevented by using an initiator which generates its own curing accelerator after activation. In this way it is possible to achieve complete curing of the synthetic resin composition within 10 sec.

The initiator according to the invention is preferably an α-aminoacetophenone derivative with formula I:

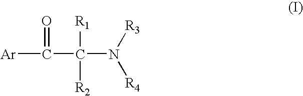

in which Ar represents C₆-C₁₄ aryl groups which are unsubstituted or substituted by one or more halogen, hydroxyl, C₁-C₄ alkyl, C₁-C₄ alkoxy, C₁-C₄ alkylthio, C₁-C₄ alkylamino, or C₁-C₄ dialkylamino or N-morpholino groups, and R₁ and R₂ independently of each other are hydrogen, C₁-C₈ alkyl, C₅-C₈ cycloalkyl, C₇-C₉ phenylalkyl, and R₃ and R₄ independently of each other are hydrogen, a C₁-C₈ alkyl, C₅-C₈ cycloalkyl or C₇-C₉ phenylalkyl, which groups may be substituted by C₁-C₄ alkoxy groups.

Preferred initiators are the following compounds with formula I, in which Ar represents a p-N-morpholinophenyl group or p-methylthiophenyl group, R₁ and R₂ independently of each other represent a C₁-C₄ alkyl or benzyl group, and R₃ and R₄ each represent methyl or, together with the nitrogen atom with which they are linked, an N-morpholino group.

Such initiators are available commercially as for example Irgacure 907 and Irgacure 369, from the company Ciba-Geigy AG.

It is pointed out that such polymerization initiators are known per se from European Patent Application No. 0 287 516. According to this publication, however, a photosensitizer is always needed in addition to the photopolymerization initiator. Moreover, only the application in blister packs is named as an application of films of the polymers formed in the medical or pharmaceutical field.

This publication does not contain any mention of the production of a composition which is suitable for application in the manufacture of a stent.

Another aspect of the present invention is the fact that a monomer composition is formed consisting of a mixture of an epoxy acrylate, an aliphatic polyester acrylate and a photo-initiator having formula I, as described above, this mixture is mixed with a polyurethane solution in dimethylacetamide, to form the synthetic resin composition, this composition is applied to a flexible plastic carrier material and the solvent is removed in a manner known per se.

Any carrier material which can be formed into a flexible film and which is pharmaceutically acceptable can be used as the plastic carrier material. A carrier which has been manufactured as a gauze is preferably used; the preferred material is nylon 6.6, although other plastics can also be used. The gauze suitably has a distance between the fibres of 40-100 mμ, preferably 60 mμ, and a fibre thickness of 20-50 mμ, preferably about 30 mμ. An example of this is a fine silkscreen sieve material, which is commonly used in bandaging.

The invention also relates to an expandable intravascular stent, which is obtained using a plastic film material according to the invention, as described above.

The invention is illustrated in greater detail by means of the following examples.

### EXAMPLE 1

A monomer mixture was formed, consisting of the following components:

a) 150 parts by weight of epoxy acrylate (Actilane 320GP30, AKZO Nobel)

b) 10 parts by weight of photo-initiator (Irgacure 369, Ciba-Geigy AG), and

c) 150 parts by weight of dipentaerythritol pentaacrylate (Photocure SR 399, Cray Valley)

by dissolving component b) in component a), with slight heating (to about 80° C.). Component c) was then incorporated into the still warm mixture, while stirring. After the whole mixture formed a homogeneous whole, it was ready for manufacture of a stent.

### EXAMPLE 2

40 parts by weight of the mixture prepared in Example 1 was thoroughly mixed with 30 parts by weight of a polyurethane solution in dimethylacetamide (Chronoflex AR, a product consisting of 60% by weight polyurethane/40% acetamide, available commercially from Cardio Tech. Int. Inc., USA) and was applied with the aid of a doctor blade to a nylon 6.6 gauze commonly used in bandaging, in a quantity of 7 g of resin mixture to 3 g of gauze material.

The gauze material so coated and impregnated was cut into portions of 10×19 mm, and these portions were wrapped on a rod with a diameter of 3 mm, forming cases. These cases were dried in a vacuum oven at 80° C. for 5 min, and then for some time at 140° C. and under vacuum until all the dimethylacetamide had disappeared.

In this way, UV curable stents of 3×10 mm were obtained which could easily be rolled up and unrolled again without damage to the synthetic resin layer applied. Curing of the synthetic resin layer was achieved within 2 sec by exposure to a LTV lamp.

1. Method for the manufacture of a plastic film material suitable for implantation, by providing a pharmaceutically acceptable, flexible plastic carrier material with a layer of a photopolymerizable synthetic resin composition containing a photo-initiator, characterized in that the synthetic resin composition is given a tack-reducing component.

2. Method according to claim 1, characterized in that the tack-reducing component is chosen from polyurethane, an initiator or a mixture thereof.

3. Method according to claim 2, characterized in that the initiator generates a curing accelerator after activation.

4 Method according to claim 1, characterized in that the initiator is chosen from an oligomer of 2-hydroxy-2-methyl-1-[4-(1-methylvinyl)-phenyl]-propanone, or an α-aminoacetophenone derivative.

5. Method according to claim 1, characterized in that the initiator is an α-aminoacetophenone derivative with formula (I): 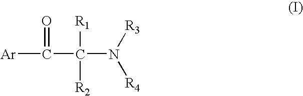
in which Ar represents C₆-C₁₄ aryl groups which are unsubstituted or substituted by one or more halogen, hydroxyl, C₁-C₄ alkyl, C₁-C₄ alkoxy, C₁-C₄ alkylthio, C₁-C₄ alkylamino, or C₁-C₄ dialkylamino or N-morpholino groups, and R₁ and R₂ independently of each other are hydrogen, C₁-C₈ alkyl, C₅-C₈ cycloalkyl, C₇-C₉ phenylalkyl, and R₃ and R₄ independently of each other are hydrogen, a C₁-C₈ alkyl, C₅-C₈ cycloalkyl or C₇-C₉ phenylalkyl, which groups may be substituted by C₁-C₄ alkoxy groups.

6. Method according to claim 5, characterized in that the initiator is an α-aminoacetophenone derivative with formula (I), in which Ar represents a p-N-morpholinophenyl group or p-methylthiophenyl group, R₁ and R₂ independently of each other represent a C₁-C₄ alkyl or benzyl group, and R₃ and R₄ each represent methyl or, together with the nitrogen atom with which they are linked, an N-morpholino group.

7. Method according to claim 1, characterized in that a synthetic resin composition is formed from a mixture of an epoxy acrylate, an aliphatic polyester acrylate and a photopolymerization initiator with formula (I): 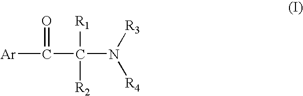
in which Ar represents C₆-C₁₄ aryl groups which are unsubstituted or substituted by one or more halogen, hydroxyl, C₁-C₄ alkyl, C₁-C₄ alkoxy, C₁-C₄ alkylthio, C₁-C₄ alkylamino, or C₁-C₄ dialkylamino or N-morpholino groups, and R₁ and R₂ independently of each other are hydrogen, C₁-C₈ alkyl, C₅-C₈ cycloalkyl, C₇-C₉ phenylalkyl, and R₃ and R₄ independently of each other are hydrogen, a C₁-C₈ alkyl, C₅-C₈ cycloalkyl or C₇-C₉ phenylalkyl, which groups may be substituted by C₁-C₄ alkoxy groups, this mixture is mixed with a polyurethane solution in acetamide, forming a synthetic resin composition, this composition is applied to a flexible plastic carrier material and the acetamide is removed in a manner known per se.

8. Method according to claim 1, characterized in that the plastic carrier material is a gauze of nylon 6.6 with a distance between the fibres of 40-100 mμ, preferably 60 mμ, and a fibre thickness of 20-50 mμ, preferably about 30 mμ.

9. Expandable intravascular stent, obtained using a plastic film material obtained by claim 1.
